(19) United States
(12) Patent Application Publication
(10) Pub. No.: US 2026/0316129 A1
(43) Pub. Date: Oct. 15, 2026

(54) PROCESS AND SYSTEM USING COMBUSTION RESIDUE

(71) Applicant: Revolutionary Plastics, LLC, Las Vegas, NV (US)

(72) Inventor: Jack Raymond Prince, Layton, UT (US)

(21) Appl. No.: 19/491,540

(22) PCT Filed: Jun. 12, 2024
(86) PCT No.: PCT/US2024/033646

§ 371 Date: Dec. 9, 2025

Related U.S. Application Data
(60) Provisional application No. 63/521,038, filed on Jun. 14, 2023.

(51) Int. Cl. B09B 3/38; B09B 3/24; B09B 3/35; B09B 101/30; C08J 3/20; C08J 3/22; C08K 11/00

(52) U.S. Cl. CPC B09B 3/38; B09B 3/24; B09B 3/35; C08J 3/203; C08J 3/226; C08K 11/005; B09B 2101/30

(57) ABSTRACT

Raw combustion residue that comes in various forms is declumped, dried and screened as necessary to form processed combustion residue that is divided into a first output of first particles at a selected size and smaller and a second output of second particles of a size larger than said selected size. The second particles are processed by a size reduction system to produce third particles that include some at the selected size and smaller and some having edges that are smoothed and rounded. The third particles and the first particles are combined to form a blend that is supplied to and combined with one or more resins and additives which are used to form products.

### BACKGROUND OF THE INVENTION

### 1. The Field of the Invention

Raw combustion residue that includes fly ash and cinders is found in a variety of forms and is treated by a system and process where it is readied for use by (as needed) dewatering, declumping, screening and drying to form processed combustion residue. The processed combustion residue is then graded or separated into first particles and second particles with the second particles being larger than the first particles. The second particles are mechanically processed by at least a jet mill into third particles sized to be the same as and less than the size of the first particles and also at least some of which are in a form which facilitates incorporation with the first particles to form a blend. The blend is then mixed with a resin and with other selected materials to form a composition which may be a master batch for later mixing with other materials to form a material useful for making product. The blend may also be used with one or more resins to form a composition useful for making a product.

### 2. The Relevant Technology

It is well known that hydrocarbons such as coal are burned to produce energy for various uses including the generation of electricity. It is also well known that the burning or combustion of coal produces or yields raw combustion residue. The raw combustion residue is comprised of whatever remains after combustion of the coal including ash (including fly ash), unburned coal, and other materials such as dirt, stones and the like which typically are referred to as cinders. Electrical generation plants typically collect the raw combustion residue and store it or transport it as a waste material. The raw combustion residue may be found stored in stacks or piles near the combustion facility where it was formed. Also, the raw combustion residue may be moved by any suitable means including, for example, trucks, train and even as slurries, to other locations such as landfills, settling ponds and the like, for longer term storage.

It may also be noted that the use of raw combustion residue, and in particular fly ash and cinders, have been identified as a suitable material for use in a number of ways including as an additive in the formation of concrete. For a discussion of use in concrete, see ASTM Designation C618-12a (2014). Also, the fly ash and cinders found in raw combustion residue, when sorted to meet particular criteria, have been identified as fillers for use with resins in a beneficial manner as disclosed in U.S. Pat. No. 7,879,939 (Prince et al.). See also: U.S. Pat. No. 8,419,405 (Prince et al.); U.S. Pat. No. 8,563,629 (Prince, et al); U.S. Pat. No. 9,481,768 (Prince); U.S. Pat. No. 9,605,142 (Prince); and U.S. Pat. No. 9,976,002 (Prince).

With the reduction of the number of coal fired power plants or conversion of such plants to natural gas as a fuel in recent years, it is understood that the supply of readily available raw combustion residue in accessible piles or mounds which can be easily processed for later beneficial use has been reduced. At the same time, it is understood that the demand for combustion residue is increasing. In turn, it is believed that users of raw combustion residue are now seeking to use available combustion residue wherever it may be found not only in the piles and mounds near the place of combustion but also in landfills, as an admixture in or as part of a settling pond systems and even as a slurry. In turn, the raw combustion material may be wet and may be in a variety of forms such as clumps, lumps and/or globs. Available raw combustion residue also is from time to time found to be contaminated with other materials found in outdoor storage ranging from leaves and twigs to stones and to even the remains of local fauna (e.g., bones of small rodents). It may also include notable amounts of other materials (as stated in ASTM C618-12) including silicon dioxide, aluminum oxide, iron oxide, sulfur trioxide, calcium oxide, magnesium oxide, sodium oxide, moisture and other materials identified as loss on ignition materials (LOI).

In some locations, it is also understood that biomass processes are being used to produce energy. That is, wood, and other plant based products are being burned to produce energy for cooking, heating and even to produce electricity. Biomass processing results in raw combustion residue which is typically in the form of small particles. The raw combustion residue may also include chunks and cinders. The raw combustion residue from biomass processes may also be stored in piles, mounds, settling ponds, and the like and may be used in the same way as raw combustion residue from coal combustion.

A resin, e.g., polyethylene and/or polypropylene, is typically selected for use in the manufacture of products such as, for example, industrial pallets, trash cans, toilet seats, and grocery carts. Desired physical properties of such products can be controlled using additives that include colorants, lubricants, stabilizers, foaming agents and various fillers. Traditionally, fillers have included one or more of calcium carbonate, talc, sawdust, glass beads and other materials including combustion residue such as fly ash and cinders to reduce the amount of resin used in the manufacture of products in an effort to lower the cost of a composition and in turn the product. The fillers in some cases are also used to enhance or control the physical properties of the composition so the final product may have desired characteristics such as hardness, ductility, elasticity, and permeability.

Notably, processes and systems to process all the raw combustion material now found in different forms such as clumps, lumps and slurries to yield a fly ash and cinder material useful in the formation of resins and compositions as well as in the formation of concrete are not known.

### BRIEF SUMMARY

A system and a process receives raw combustion residue which is then selectively dewatered, declumped, dried and/or screened to form processed combustion residue. The processed combustion residue is graded or classified by grading means to form first particles and second particles. The first particles are of a selected size and smaller (e.g., an effective diameter or maximum dimension of 13 microns and smaller) and found in first effective shapes (e.g., spherical and similar). The second particles are larger than the first particles. The second particles are sent to size reduction means where the second particles are mechanically formed into third particles having the selected size of and smaller. The third particles are also at the same time formed into shapes that include the first effective shapes and also second effective shapes which differ from the first effective shapes that empirically have been found to blend well with the first effective shapes.

The system and process includes blending means to blend particles and is connected to receive the first particles from the grading means and the third particles from said size reduction means. The blending means is operable to blend the first particles and the third particles to form a blend or blended particles. A selected resin is mixed together with one or more selected additives and with the blend or the blended particles to form a mixture that is supplied to a product formation arrangement which operates to form products.

In selected embodiments, the source of raw combustion residue is typically presented sequentially in one or more or in all forms including one form having clumps and lumps, another form containing liquids, and another form essentially without liquids. The raw combustion residue may be expected to include non combustion material. In operating the process and the system, the raw combustion material is typically provided in batches sized so that the system may be set to operate with one form of raw combustion residue for some time (e.g., hours, days) before changing to another form.

In preferred configurations, the residue preparation structure preferably includes screening means for screening the raw combustion material to separate the non combustion material from the raw combustion material to form screened combustion material. The residue preparation structure also includes a declumper or declumping means to mechanically change the lumps, clumps and globs into declumped combustion material. The residue preparation structure also includes drying means to dry the raw combustion residue and/or the declumped combustion material and supply dry combustion material. The screening means, the declumper and the drying means are interconnected so that the raw combustion residue is processed as needed and selectively directed through one or more or all of the declumper, screening means and drying means to form and to supply processed combustion residue.

In a preferred configuration, grading means is provided to grade the processed combustion residue into first particles and second particles. The first particles are at an effective size and below a top cut which is said to be the largest of all the first particles. Thus, the first particles include the top cut and all particles which are smaller. The second particles are all those which are larger than the first particles.

In the process and system as claimed, the second particles are supplied to size reduction means which operates to produce third particles. The third particles are formed mechanically to have an effective size at and below the top cut of the first particles. The size reduction means may include a mechanical reducer and will include a jet mill. The second particles may be supplied to at least a jet mill and in some preferred configuration to the mechanical reducer and then to the jet mill to form the third particles. The third particles are shaped to have some particles that are the shape of the first particles and some that are of different shapes. The shapes of the third particles have been found to blend with the first particles. A mixing structure combines and blends the first particles with the third particles to form a blend or blended particles.

In the disclosed system and method, the blend or blended particles are supplied to a mixing structure. A desired resin and selected additives are also supplied to the mixing structure. A second resin may also be added to the mixing structure. The mixing structure is then operated to mix all to form an output that is supplied to a product forming arrangement which is then operated to form products.

In selected arrangements, the mixing structure may include a master batch formation arrangement to receive the third particles and/or the blended particles as well as the additives and the first resin. The master batch formation arrangement is operated to form a master batch. A mixer may also be included to receive the second resin and the master batch to form the output for use in forming products. In alternate configurations, the additives include, for example, any one or more or all of an acid scavenger, an antioxidant, an encapsulator, an impact modifier and silane.

### BRIEF DESCRIPTION OF THE DRAWINGS

To further clarify the above and to show the advantages and features of the present process and system as here disclosed, a more particular description of the process will be rendered by reference to the appended drawings and pictures. It should be understood that the drawings and pictures depict only a typical embodiment of the process and system; and therefore the drawings and pictures are not to be considered limiting of the scope of the appended claims. More specifically:

FIG. 1 is a block diagram of a method and system for forming a composition as disclosed;

FIG. 2 is a photograph of raw combustion residue enlarged to 500 times;

FIG. 3 is an enlarged photograph of the first particles enlarged 1000 times;

FIG. 4 is an enlarged photograph of the third particles enlarged 1000 times; and

FIG. 5 is an enlarged photograph of the blend.

### DESCRIPTION

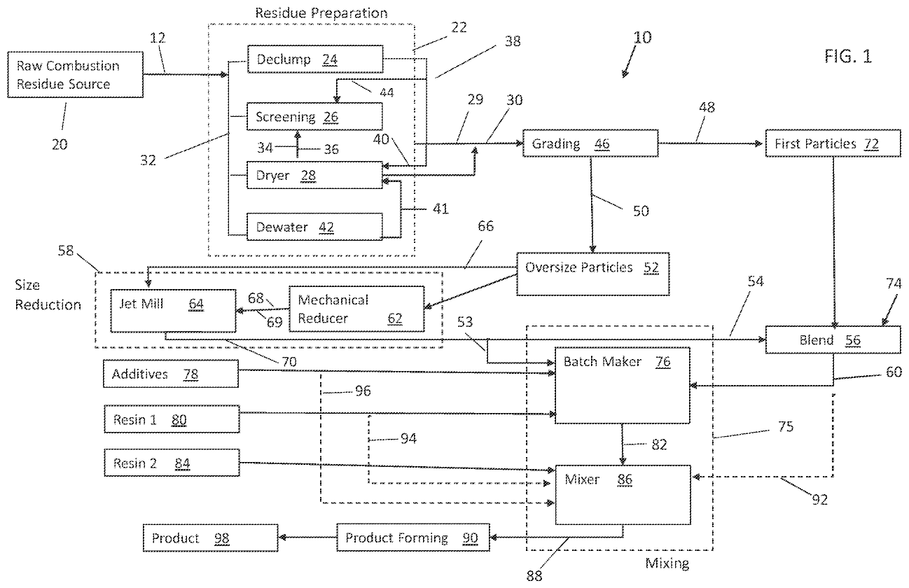

Reference will now be made in more detail to FIG. 1 which illustrates a new and innovative system and a new and innovative process for forming the desired compositions. It should also be understood that the drawing and the examples herein set forth are not intended to limit the scope of the claims. Rather, alternatives, modifications and equivalents are within the spirit and scope of the inventions herein disclosed and claimed.

The system 10 illustrated or depicted in FIG. 1 operated as herein set forth leads to the formation of compositions such as resins that are used to form a product by various suitable means such as injection molding, extrusion, vacuum molding, and by the use of any other process and machine useful for forming products from resins. The process and system 10 of FIG. 1 may also be used with cements to form concrete products.

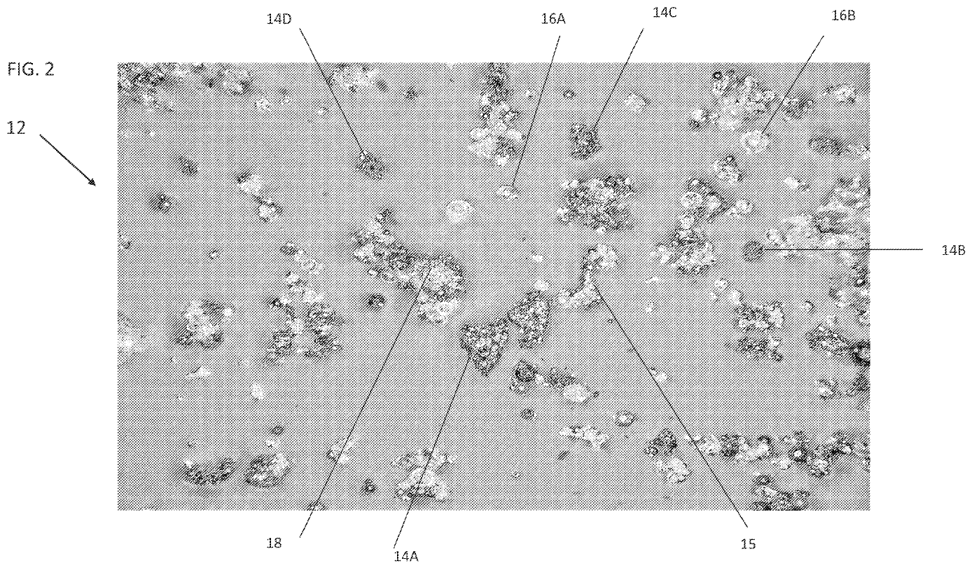

Raw combustion residue 12 is the residue that remains after combustion of a selected hydrocarbon such as coal. Coals are understood to vary in composition based on where they are found or harvested. That is, coal typically includes various materials that are considered non combustibles. The non combustibles are contained in or trapped in the coal such as dirt, rocks, pebbles and other materials. And in addition, the raw combustion residue also contains some of the coal which did not actually combust. FIG. 2 is a photograph of raw combustible material 12 positioned on a clear glass substrate or plate taken through a digital microscope manufactured by KEYENCE, Model VHX 5000 having a VH 2500 R zoom lens RZ×500×5000. In FIG. 2, the magnification is 500. In FIG. 2, one can easily see small chunks of unburned coal such as, for example, pieces 14A, 14B, 14C and 14D. One may also see other particles of different materials and sizes some of which are non combustible materials such as particles 16A and 16B. Some particles are also combinations of non combustible materials formed with unburned coal such as particle 15.

Raw combustion residue 12 may also be the residue of a BIOMASS combustion process in which wood, leaves, twigs, and the like are combusted. Other processes now or hereinafter known that produce a waste or residue material having an effective particle size diameter of about 0.25 inch or less may also provide raw combustion residue 12 and may be processed as herein disclosed.

The raw combustion residue 12 comes from a source 20 which can be from a BIOMASS combustion process as discussed and from any hydrocarbon combustion process. The raw combustion residue 12 may be found in various locations having a commercially suitable amount available for use. The raw combustion residue 12 may be found in one or more piles, mounds or heaps near a commercial power plant. Raw combustion residue 12 may be moved as a slurry to transport raw combustion residue away from its place of creation to and thus found proximate to and forming settling ponds and drying ponds. In turn, raw combustion residue 12 can be found next to, part of and in the bottom of settling ponds and drying ponds. And raw combustion residue 12 may also be found in landfills because the raw combustion residue was previously transported to the landfill as a waste. So, in effect the raw combustion residue can come from any available source in a variety of forms including clumps and lumps and globs, and as a slurry from, for example, settling ponds. Clumps and lumps may also form when stored in a powder or dirt in mounds or piles as rain and possible snow intermix. In all forms, the raw combustion residue is found with various other non combustible materials mixed in.

As seen in FIG. 1, the raw combustion residue 12 is supplied to a residue preparation system 22 which is here depicted to include a declumping means such as declumper 24, screening means such as screening device 26 and drying means such as dryer 28. The residue preparation system 22 operates to process the raw combustion residue 12 into processed combustion residue 30 delivered to grading means 46 via output conduit 29.

As noted hereinbefore, the raw combustion residue 12 is found in a variety of forms one of which is a dry granular or particulate form and another which includes clumps, lumps and globs. And in yet other forms, the raw combustion residue may be in a liquid form such as a slurry and even in a viscous form. In all forms, the raw combustion residue 12 may include other foreign materials such as twigs, leaves, trash and other materials that can collect and be found accumulating in and around the raw combustion residue 12 in an outdoor environment.

An operator may be present during the operation of the system 10 to direct the raw combustion residue 12 for suitable processing through the residue preparation system 22. The operator causes the raw combustion residue 12 to be directed to one of or more of the declumper 24, the screening device 26 and the dryer 28. For example, should the raw combustion residue be in a slurry or viscous form, it need not be declumped and is not yet in a form for screening. So the operator would cause it to be sent to the dryer 28 for drying. After it is dried, the dried raw combustion residue 36 would thereafter be sent to the screening device 26 via a first conduit 34. Upon screening in the screening device 26 to remove leaves, twigs, stones, bones, and whatever other trash that has accumulated or collected in the raw combustion residue 12, the raw combustion residue has been both dried and screened so that all the particles are at or less than 1 millimeter in diameter or effective diameter and are the output of the residue preparation system 22 to become processed combustion material 30. A particle is said to have an effective diameter when is it is non-spherical and even in some other shape where it will have several different dimensions but will have one dimension larger than others that is sometimes called the diameter and of a size such that the non spherical particle will pass through a screen or filter set to pass spherical particles of that diameter.

Should the operator determine that the raw combustion residue 12 has lumps, clumps and globs, the raw combustion residue 12 would then be directed through inlet lines 32 to the declumper 24. The declumper 24 would operate to mechanically change the lumps, globs and clumps to declumped material 38. The declumper 24 may be any machine that operates to hammer or mash material. If the declumped material 38 is then assumed or determined to contain moisture, it would then be directed next to the drying device 28 via a second conduit 40 where it would be dried and then delivered via first conduit 34 to the screening means 26 for further processing to remove whatever part of the leaves, twigs, stones and other trash that may remain to become processed combustion residue 30.

If the operator determines that the raw combustion residue 12 is dry and does not have lumps and clumps and globs, the raw combustion material may be directed through inlet lines 32 to the screening device 26 where it is screened to remove, for example, the twigs, leaves, animal bones, and other trash. Thereafter it is directed to the output conduit 29 as the processed combustion residue 30.

The declumper 24 of the residue processing system may be any one of a wide variety of machines to mechanically convert the lumps, globs and clumps into a stream of declumped material 38 which could be granular, powdery or particulate in form. It may be reduced in size so that it is in a form and functions much like fluid. Hammer mills, crushers, pin mills, ball mills and the like all should be suitable based on the volume of the raw combustion residue to be processed. The company known as Frank Miller of Livingston, New Jersey offers a line of machines including DELUMPER® crushers that may be particularly useful to process raw combustion residue 12 found or delivered with lumps, globs and clumps.

As noted herein, the raw combustion residue 12 exits the declumper 24 as a stream of declumped material 38 which may be wet or moist so that it needs to be processed through the drying device 28. Thereafter, declumped material 38 when dried is typically directed to the screening means 26 via second conduit 34 to remove other undesired items thereafter becoming processed combustion residue 30.

While an operator or user may align the system to process the raw combustion residue in a desired configuration for reasons known to the operator such as to reduce the cost of operating the residue preparation system 22, it should be understood that the operator may align the system so that all raw combustion residue may be processed first through the declumper 24 even if it has no lumps, clumps and globs and then through the drying device 28 even if not moist or wet and then to the screening means 26 even if it does not have or contain leaves, twigs, bones, stones and other trash. Alternately a series of solenoid valves or similar valves may be used and operated by signals from detectors placed to sense the flow and nature of the material moving in the various conduits such as the inlet lines 32, first conduit 34 and second conduit 40.

For example, sensors of various types may be used to measure or detect the moisture in the declumped material 38 including possible capacitive grain and soil moisture detection devices available from Temu, 31 St. James Avenue, Suite 355, Boston, Massachusetts 02116 and from Agratonix, LLC, 1780 Miller Parkway, Streetsboro, Ohio 44241. If the declumped material 38 has a moisture content that would inhibit or preclude or interfere with effective screening, then the declumped material 38 would operate a solenoid valve or an equivalent valving to direct the declumped material 38 into drying device 28 such as a 400 Dryer/Cooler available from Witte Company, Inc., 507 Route 31 South, Washington, New Jersey 07882. The sensors (not shown) may also simply alert an operator to direct the flow as determined by the operator.

As noted before, the raw combustion residue 12 may be provided in several forms including as a stream in liquid form including a slurry and in viscous form. While declumping is not needed, the raw combustion residue 12 in the liquid form is typically dewatered using dewatering means such as a dewater device 42 to remove water. Suitable industrial dewatering devices include those available from Dorr-Oliver/FL Smith, 7158 S. FLSmith Dr. Midvale, Utah 84047. After dewatering, the dewatered material is then directed to the drying device 28 via conduit 41 for further drying and then for screening via line 34 by the screening device 26. Dewatering can also be affected by various belt dewatering machines as well as larger centrifuges.

While the declumped material 38 is typically sent to the drying means 28, if it is dry, it may be sent directly to the screening means 26 via third conduit 44. But as noted, all of the raw combustion material 12 that is processed through the residue preparation system 22 is directed to a screening means 26 to screen out leaves, twigs, pebbles, stones as well as other things like the bones of birds and small animals. There are a wide variety of industrial screening machines suitable for processing the volumes involved such as vibratory screening devices also available from Witte Company, Inc., 507 Route 31 South, Washington, New Jersey 07882.

After declumping, drying and screening, as needed, by the residue preparation system 22, the processed combustion residue 30 proceeds to a grading device 46 which functions to grade or classify the processed combustion residue 30 into a first output 48 of first particles and a second output 50 of second particles. Various screening machines and structures may be used to effect the desired classification. There are several types of classifiers that can be used. For example, Prater Industries, Inc. of 2 Sammons Court, Bolingbrook, Illinois 60440 offers a line of rotating classifiers that may be adaptable to produce the first output 48 of first particles 72 which may also be referred to as fines because the particles are small (e.g., fine particles could be those at or below a very small dimension). The fines or first particles 72 are also those which are sometimes herein referred to as those having a top cut where all particles are at or smaller than a particular effective size. For example, a top cut of d 100 (the 100 means 100% of all particles) are at or below a selected dimension such as a diameter of a sphere which may be, for example, 50 microns, 35 microns and even 13 microns.

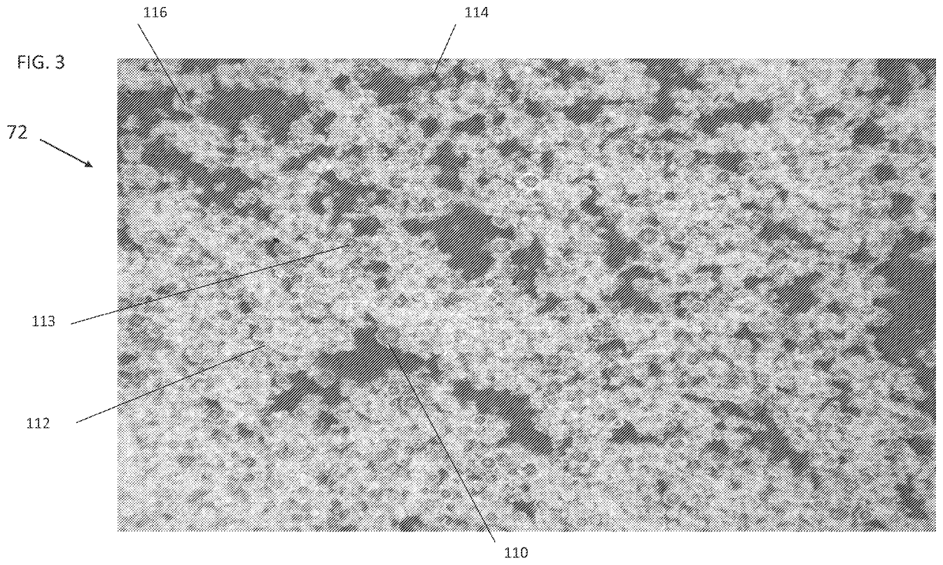

The first output 48 or first particles are notably small and are also said to have a particle size distribution (PSD) at and below the selected size. While many of the particles are spherical in shape, not all of the first particles are spherical. Some of the first particles of the first output 48 have first effective shapes which include spherical particles and particles that are not spherical. Such particles are in turn sometimes described by their effective diameter. As stated hereinbefore, the effective diameter is deemed to be the dimension that allows the particle to pass through a mechanical filter set to pass spherical particles of that size. FIG. 3 is a photograph of first particles 72 taken on a glass substrate using the digital microscope manufactured by KEYENCE, Model VHX 5000 having a VH 2500 R zoom lens RZ×500×5000. In FIG. 2, the magnification is 1000. In FIG. 3, one can easily see small spherical particles 110, 111 and 112 as well as non spherical particles 114 and 116.

The second output 50 or the second particles of the grading device 46 are all particles in the processed combustion residue 30 that are larger than the first output 48 and in turn larger than the top cut and are sometimes referred to as the oversize particles 52. The oversize particles 52 are processed in a size reduction system 58 into third particles 54 which are now reduced in size to be at the top cut of the first particles and smaller. And the third particles 54 have some particles that are spherical and others that are not spherical. The third particles 54 are sent to the blending means 56 to produce a blend 60 of the first particles 72 and the third particles 54 as hereinafter discussed.

The size reduction system 58 operates to convert the oversize particles 52 into third particles 54 which have the same top cut as the first particles 72. Some of the third particles 54 are the same as the shapes of the first output 48 and some of the third particles are of a different shape from that of the first output 48.

The size reduction system 58 is here shown to include a mechanical reducer 62 and a jet mill 64. The oversize particles 52 are typically sent to the mechanical reducer 62 which may be any of a suitable ball mill, hammer mill, or the like, to mechanically impact and, in effect, smash the oversize particles 52 to break them into smaller particles. Orbis Machine, LLC of 2001 S. Prairie Ave., Waukesha, Wisconsin 53189 has a line of ball mills one of which may be suitable in some applications to mechanically change the oversize particles 52 to an output 68 of smaller particles 69 which may also be known as milled material.

The output 68 of smaller particles 69 or milled material from the mechanical reducer 62 contains a variety of differently shaped and sized particles including a large number of particles which are asymmetrical, or irregular given their formation by mechanically breaking or smashing of the oversize particles 52. In turn, the output 68 of smaller particles 69 or milled material is directed to a jet mill 64 which operates to circulate the smaller particles 69 to impact one against the other to smooth or round edges of the asymmetrical or irregular pieces or particles and to reduce the larger particles to a desired size. A wide variety of jet mills may be found commercially including those of Hosokawa-Alpine AG Peter Doerfler Strasse, 13-25, 86199 Augsburg, Germany, Hosokawa-Alpine offers a line of jet mills that may be suitable. Qingdao Mills Power Engineering Equipment Ltd, Building 6, No. 163 Xiazhuang Road, Licang District, Qingdao, China also offers what are here believed to be suitable jet mills.

The output 70 of the jet mill 64 passes through a discharge opening or orifice (not shown) or similar arrangement sized to control the size of the particles exiting the jet mill 64. Typically, the size of the opening or orifice or other structure is selected to allow particles of a selected size and smaller to pass so that the larger particles remain within the jet mill 64 and continue to impact against each other until they are reduced in size to fit through the discharge opening to be the output 70 and in turn become the third particles 54.

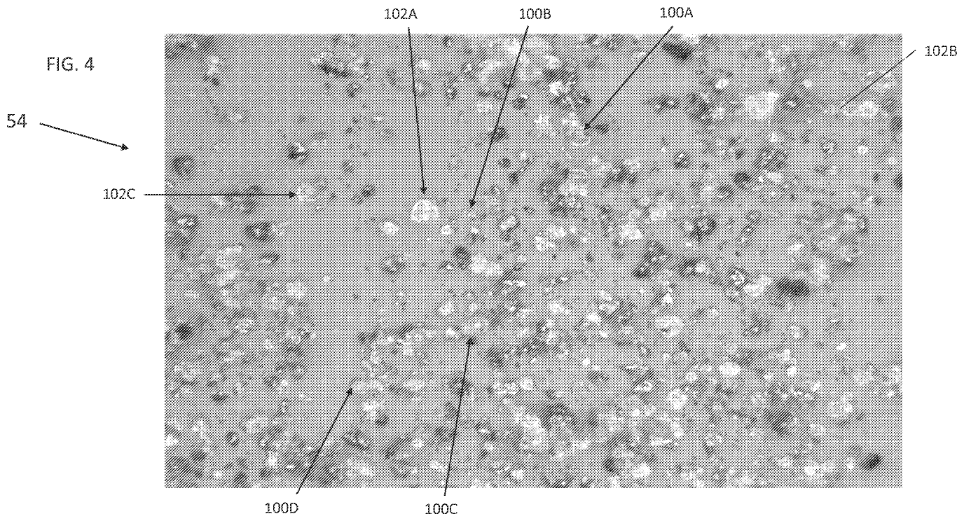

As seen in FIG. 4, the photograph of the third particles 54 taken on a glass substrate or plate at a magnification of 1000 using the digital microscope manufactured by KEYENCE, Model VHX 5000 having a VH 2500 R zoom lens RZ×500×5000. In FIG. 4, one can easily see small particles have exited the jet mill 64 with the same top cut d100 of the first particles 72 with some particles 100A, 100B and 100C of the third particles 54 spherical in shape and another portion 102A, 102B and 102C of the third particles 54 having one or more edges which are rounded or smoothed from processing in the jet mill 64. The smoothed edges of the particles 102A, 102B and 102C of the third particles 54 that are not spherical have been found to enhance the blending of the third particles 54 with the first particles 72 in the blending means 60.

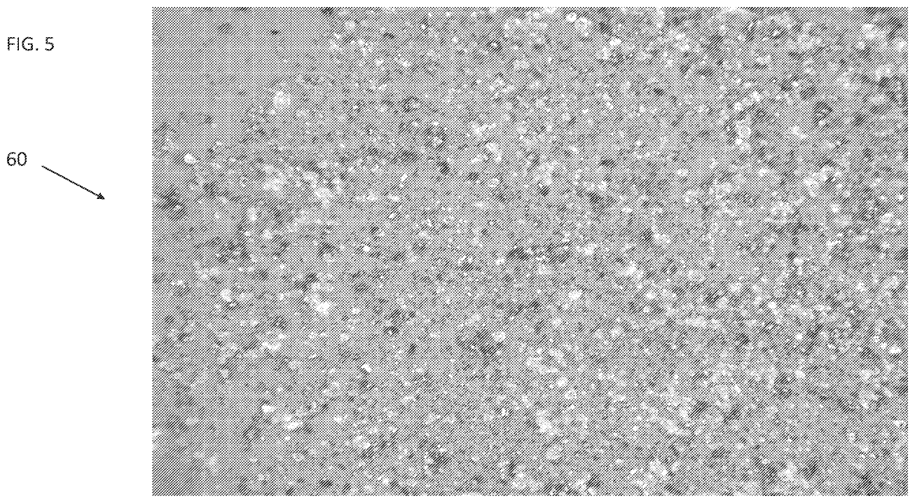

FIG. 5 shows the blend 60 where about 15% of the blend 60 is the top cut d100 of the first particles 72 set at 13 microns and about 85% of the blend 60 is third particles 54 having the same top cut d100 set at 13 microns. FIG. 5 shows the particles of the blend 60 well mixed and evenly disbursed.

Returning to FIG. 1, the oversize particles 52 may be sent to the mechanical reducer 62 or may be sent via fourth conduit 66 directly to the jet mill 64. The use of a mechanical reducer 62 is up to the user the choice of which is made based on the nature and characteristics of the raw combustion residue 12 and in turn the processed combustion residue 36. The third particles 54 from the jet mill 64 and the size reduction system 58 produce an output 70 which may be directed to the blend means 56 or through line 53 to structure and a process for forming a master batch 76. The output 70 is the stream of third particles 54 that have a particle size distribution (PSD) that ranges from the top cut which may be set at any desired diameter such from about 13 microns to about 100 microns with particles as small as about 200 nanometers to as large as 100 microns.

In mixing the stream of third particles 54 with the stream of first particles 72 in the blending means 56, the resulting blend 60 also has a particle size distribution selected for use with another material which is here shown in FIG. 1 to be a resin 80 chosen for the manufacture of products as herein after discussed. The material into which the blend 60 is combined may also be cement or similar. Suitable ribbon blenders and loss-in-weight blenders may be useful to mix the stream of third particles 54 with the stream of first particles 72. A suitable loss-in-weight blender may be found at Thayer Solids Flow Control, 91 Schoosett Street, Pembroke, Massachusetts 02359. Hosakawa Micron Powder Systems, 10 Chatham Road, Summit, New Jersey 07901 offers a line of ribbon blending machines.

The process of the system 10 of FIG. 1 functions to produce a blend 60 that functions as a filler comprised of particles which can vary in size from large to small.

Normally the particles may range in size from up to about 1000 microns to sub micron in size. The blend 60 preferably has a particle size distribution in which at least ten percent (10%) of the total number of particles are less than 1 micron (i.e., submicron) in effective diameter where 1 micron is 1×10 meter (also written as 1 μm). More preferably, over half of the total number of particles of the blend 60 are sub micron. Desirably, over 90% of the total number (quantity) of particles of the blend 60 are less than 1 μm (micron) in effective diameter. The particles of the blend 60 are generally spherical with a diameter as stated. But some of the particles of the blend 60 are not spherical but in some other shape which may best be described by using the effective diameter which is the diameter which best approximates the particle if it were spherical. It has been found that the first particles 72 and the third particles 54 mix with each other when the non spherical particles of the third particles 54 are present and in turn lead to a blend 60 that is formed by mixing in the blending means more completely and more efficiently.

While the blend 60 is presently entirely combustion residue, it should be understood that the other particles may be added in the blending means 56 which may be any suitable filler 74 such as saw dust, glass beads, and the like. The blend 60 may also be treated before it is mixed in the mixing means 75 as hereinafter set forth.

The blend 60 may be supplied to a mixing means 75 for mixing the blend 60 with additives 78 and resin 80 to provide an output 88 for making product 98. The mixing means may be or include batch maker 76 which is operated to form a master batch 82 with the use of the additives 78 and a first resin 80. The additives 78 may include colorants which may be added at this early stage. The additives 78 may also include silane mixed with a small amount of dry peroxide. That is, the silane and dry or powder peroxide are additives 78 which are mixed together with the blend 60 and first resin 80 in the batch maker.

The additives 78 may also include an acid scavenger like hydrotalcite which may be introduced into the master batch 82 in small quantities to reduce the acid that can form when mixing the blend 60 with some of the other additives 78. An antioxidant may also be used as an additive which may be a benzene material such as ANOX® NDB® blend available from Chemtura which has offices throughout the world including offices in Middlebury, Connecticut. ALKANOX® is a phosphorous based antioxidant that can be used and is available also from Chemtura and may be used as an antioxidant. Combinations of ANOX® and ALKANOX® antioxidants may be used as additives 78 as well.

An impact modifier is an optional additive 78 which is a low melt or fractional melt resin that has a melt flow index (MFI) at or below 15 and typically a melt flow index of less than 1, as measured using ASTM D1238. The impact modifier may even be recycled plastic or waste production resin called “regrind”, adding to the sustainability features of the process. Marlex® HHM 5202 high density polyethylene and Marlex® HHM 5502 high density polyethylene (HDPE) available from Chevron Phillips Chemical Company of Woodlands, Texas have been found to be particularly suitable as an impact modifier. Styrenic block copolymer, such as SEPTON® copolymer may also function as an impact modifier.

The batch maker 76 depicted in FIG. 1 is any suitable machine or arrangement can be used to mechanically mix the blend 60 with any of and all of the additives 78 and the first resin 80. The batch maker 76 may also have a cooling jacket (not shown) to allow for cooling as needed.

As seen in FIG. 1, the batch maker 76 may be operated in a way to produce a master batch 82 intended for further mixing in a second mixer 86 with a second resin 84 to produce the output 88 which in effect may be any suitable thermoplastic or thermoset material and may even be a rubber like material. The second resin 84 may be more of the first resin 80 or it may be a fractional melt resin. As also shown in FIG. 1, the blend 60 may be supplied by line 92 (dotted) as well as the first resin 80 by line 94 (dotted) and additives 78 by line 96 (dotted) directly to the second mixer 86 which is then operated to produce the output 88.

The output 88 of the second mixer 86 is supplied to a product forming device 90 which may be, for example, an injection molding machine, an extrusion machine, a vacuum forming machine, a press or stamping machine or any other machine or device configured to receive output 88 and produce a product 98.

In addition to and as another option, the resin may be LDPE (low density polyethylene and or LLDPE (linear low density polyethylene) which may be combined with HDPE (high density polyethylene) to be the first resin 80. The combination reduces the time the final compound needs to crystallize during production. In other words, the final compound crystallizes more rapidly, and in turn the final composition 88 will set up faster in the molding process than processes in which silane is absent from the master batch formulation. A faster crystallization allows one to remove the final product 98 sooner or faster than in processes where silane is absent. Faster cycle time leads to faster through put and increased production in a shorter period of time.

Inasmuch as the blend 60 is in effect a mineral composite and may be a ceramic or ceramic-like material in particulate form (e.g., a powder), it is believed to be important that each particle of the filler which is blend 60 be at least partially coated, and ideally totally encapsulated. At present, total encapsulation of the particles is believed to be accomplished by an additional compatibilizer or encapsulator as an additive 78. A polyolefin grafted with maleic anhydride, also called a maleated polyolefin, with a melt flow index sufficient to facilitate some or all coating of the fly ash particles is believed to be suitable because when heated it more efficiently wets the fly ash particles.

In operation, the system 10 is typically operated so that the output of the machines will yield a top cut or d100 of a particular size which is here set at about 13 microns. The larger pieces entering the residue preparation system 22 are processed by the declumper to produce material that when screened is effectively 1 mm in diameter or effective diameter. The system 10 may be set up or initially operated by using a particle analyzer such as a Microtrac which can be obtained from Keyence Corporation Of America, 500 Park Boulevard, Suite 200, Itasca, Illinois 60143. The user thus can measure the smallest particle to the largest as well as the particle size distribution (PSD) and ensure that the components of the system are at settings or configurations to produce the d100 that is desired as well as the blend 60 that is desired. Given that the supply of the raw combustion material 12 may be expected to be in large amounts, manual operation using a particle analyzer to set up and then test to ensure proper operation is believed to be feasible. In some operations where the raw combustion residue is inconsistent, detectors, sensors and automated valves may be used with analog settings or controlled by computer setting or an ASIC to control the components of the system 10 to ensure that the process operates to produce a blend having the desired particle size distribution.

While components may be included to provide for automatic operation, the present arrangement allows for a user to set up the system 10 for raw combustion residue arriving or supplied in a particular form and/or what may be regarded as having a particular quality. Once set up and running, the system and the settings on the machines that are the various components may not change for long periods of time which may be many days and even weeks.

1. (canceled)

2. A process comprising:
providing raw combustion residue from a source of raw combustion residue having at least one of lumps, clumps, moisture, and non combustion material;
providing residue preparation means having:
declumping means to remove any of said lumps and clumps in said raw combustion residue,
screening means for screening said raw combustion residue to remove any of said non combustion material to form screened combustion material, and
drying means to dry said raw combustion residue,
said residue preparation means being configured to receive said raw combustion residue from said source of raw combustion residue and to selectively declump, screen and dry said raw combustion residue to form processed combustion residue;
supplying said raw combustion residue from said source of raw combustion residue to said residue preparation means;
operating said residue preparation means to form processed combustion residue by selectively performing at least one of declumping, screening, and drying said raw combustion residue;
providing grading means for grading said processed combustion residue;
supplying said processed combustion residue to said grading means;
operating said grading means to form a first output of first particles sized to be no larger than a first selected size, said first output including first particles having first effective shapes, and a second output of second particles sized larger than said first selected size of said first particles;
providing size reduction means connected to receive said second particles from said second output and operable to form said second particles into third particles:
operating said size reduction means to form said third particles sized to be no larger than said first selected size and to form a portion of said third particles into said-first effective shapes and to form another portion of said third particles to have second effective shapes which are different from said first effective shapes;
providing blending means for blending said first particles from said first output of said grading means and said third particles from said size reduction means;
connecting said blending means to receive said first particles from said first output of said grading means and said third particles from said size reduction means;
operating said blending means to blend said first particles and said third particles to form blended particles;
providing resin selected for forming a product;
providing additives selected for combination with said resin to form said product;
providing mixing means for mixing said resin with said additives and with at least one of said blended particles and said third particles to form a mixture;
operating said mixing means to mix said resin, said additives, and at least one of said blended particles and said third particles to form said mixture;
providing means for forming said product and supplying said means for forming said product with said mixture; and
operating said means for forming products to form said product.

3. The process of claim 2, wherein said drying means is connected to receive and selectively dry at least one of said raw combustion residue, said screened combustion material, and said declumped combustion material to form dry combustion material, wherein said drying means is connected to supply said dry combustion material to said screening means for screening said raw combustion material, and connected to the output of said residue preparation means. and
wherein at least one of said declumping means, said screening means and said drying means is connected to supply said processed combustion residue,

4. The process of claim 2, wherein the size reduction means includes a jet mill and a mechanical reducer, said mechanical reducer being connected to receive the second output from said grading means, said mechanical reducer being operable to form a milled material which is then supplied to said jet mill, said jet mill being configured and operated to form said third particles from said milled material,

5. The process of claim 2, wherein said size reduction means includes a jet mill connected to receive the second output from said grading means, said jet mill being operable to form said third particles.

6. The process of claim 2, wherein said raw combustion residue includes material in form of a slurry and further including dewatering means connected to receive said raw combustion material in the form of said slurry, said dewatering means being operable to dewater said slurry to form dewatered raw combustion material and said dewatering means being connected to supply said dewatered raw combustion material to said dryer means.

7. A system using raw combustion residue in forming a product, said system comprising:
residue preparation means having at least one of declumping means to declump said raw combustion residue, screening means for screening said raw combustion residue, and drying means to dry said raw combustion residue, said residue preparation means being configured to receive raw combustion residue from a source thereof and configured to selectively declump, screen, and dry said combustion residue to form processed combustion residue, wherein said raw combustion residue selectively includes non combustion material, wherein said screening means for screening said raw combustion material is operated to separate said non combustion material from said raw combustion material to form screened combustion material;
grading means connected to receive and grade said processed combustion residue to form a first output of first particles having a first selected size and smaller and to form a second output of second particles having a size larger than said first selected size of said first particles;
size reduction means connected to receive and operable to change the second particles to third particles sized to be at least one of said first selected size and smaller than said first selected size, said size reduction means being operable to produce said third particles, and some of which have edges that are smoothed and rounded;
blending means connected to receive said first particles from said grading means and said third particles from said size reduction means, said blending means being operable to blend said first particles and said third particles to form a blend;
resin selected for forming the product;
additives for combination with said resin;
mixing means configured to receive said third particles and at least one of said blend, said resin, and said additives and operable for mixing said third particles with the at least one of said blend, said resin, and said additives to form a mixture useful for forming said product.

8. The system of claim 7, wherein said source of raw combustion residue is a storage location having raw combustion residue from a combusted fossil fuel that leaves a residue after combustion.

9. The system of claim 7, wherein said raw combustion residue presents in at least one of a form having clumps and lumps, a liquid-containing form, and an essentially liquid-free form and wherein only one of the form having lumps and clumps, the liquid-containing form, and the essentially liquid-free form is selected for processing as said raw combustion residue.

10. A process using raw combustion residue to form a master batch for use in forming a product, said process comprising;
providing raw combustion residue from a source of raw combustion residue, wherein said raw combustion residue selectively includes non combustion material;
providing residue preparation means having at least one of declumping means to declump said raw combustion residue, screening means for screening said raw combustion residue, and drying means to dry said raw combustion residue, said residue preparation means being configured to receive said raw combustion residue from said source of raw combustion residue and configured to selectively declump, screen and dry said combustion residue to form processed combustion residue, wherein said screening means for screening said raw combustion separates said non combustion material from said raw combustion material to form screened combustion material;
supplying the raw combustion residue to the residue preparation means;
forming said processed combustion residue by selectively performing at least one of declumping, screening, and drying on the raw combustion residue with the residue preparation means:
providing grading means connected to receive and grade said processed combustion residue to form a first output of first particles having first effective shapes and a first selected size and smaller than said selected size and a second output of second particles having a size larger than said selected size of said first particles;
receiving and grading said processed combustion residue to form said first output:
providing size reduction means connected to receive and operable to reduce the size of said second particles to form third particles sized to be said selected size and smaller than said selected size, and said third particles having both first effective shapes and second effective shapes different from said first effective shapes;
forming said third particles by reducing the size of said second particles using the size reduction means:
providing blending means connected to receive said first particles from said grading means and said third particles from said size reduction means, said blending means being operable to blend said first particles and said third particles to form a blend-;
forming a blend of said first particles and said third particles using the blending means:
providing a first resin selected for forming a product;
providing at least one additive for forming a master batch;
providing mixing means to receive and mix said first resin, said at least one additive. and at least one-of said blend and said third particles to form a master batch;
mixing said first resin, said at least one additive, and said at least one of said blend and said third particles using the mixing means to form said master batch;
providing a product-forming means to receive said master batch and to produce a product:
producing said product using said product forming means.

11. The process of claim 10, further comprising providing a second resin and mixing said second resin with said master batch to form a material to be used in forming said product.

12. The process of claim 11, wherein said source of raw combustion residue is a storage location that has combustion residue from a combusted fossil fuel that leaves a residue after combustion.

13. The process of claim 710, wherein said raw combustion residue is in at least one of a form having clumps and lumps, a form containing liquids, and a form essentially without liquids, and wherein at least one of said form having clumps and lumps, said form containing liquids, and said form essentially without liquids is selected to supply as said raw combustion residue.

14. (canceled)

15. The process of claim 11, wherein said clumps and lumps are of a size greater than said selected size, wherein said declumper receives and declumps said lumps and clumps to provide declumped combustion material, said declumper being connected to supply said declumped combustion material to one of and both of said screening means for screening and said drying means to dry.

16. The process of claim 11, wherein said drying means is connected to selectively dry at least one of said raw combustion residue, said screened combustion material, and said declumped combustion material to form dry combustion material for supplying to at least one of said screening means for screening said raw combustion material, and an output of said residue preparation means, and wherein at least one of said declumping means, said screening means, and said drying means are connected to supply said processed combustion residue to said grading means.

17. The process of claim 11, wherein the size reduction means includes a mechanical reducer to receive the second output from said grading means, said mechanical reducer being operable to form milled material which is supplied to a jet mill, and wherein said jet mill is operated to form said second particles.

18. The process of claim 10, wherein the at least one additive is at least one of an acid scavenger, antioxidant, an encapsulator, an impact modifier, and silane,

19. The process of claim 2, wherein said source of raw combustion residue is a storage location having raw combustion residue from a combusted fossil fuel that leaves a residue after combustion.

20. The system of claim 7, wherein the size reduction means includes a jet mill and a mechanical reducer, said mechanical reducer being connected to receive the second output from said grading means, said mechanical reducer being operable to form a milled material which is then supplied to said jet mill, said jet mill being configured and operated and configured to form said third particles from said milled material.

21. The process of claim 10, wherein the size reduction means includes a jet mill and a mechanical reducer, said mechanical reducer being connected to receive the second output from said grading means, said mechanical reducer being operable to form a milled material which is then supplied to said jet mill, said jet mill being configured and operated and configured to form said third particles from said milled material.

22. The process of claim 10, further comprising:
providing dewatering means connected to receive said raw combustion material in the form of a slurry, wherein said raw combustion residue includes a slurry, wherein said dewatering means is operable to dewater said slurry to form dewatered raw combustion material, and said dewatering means is connected to supply said dewatered raw combustion material to said dryer means;
dewatering said raw combustion residue; and
supplying said dewatered raw combustion material to said dryer means.

23. A system using combustion residue, comprising:
a residue preparation system having at least one of:
a declumping means configured to remove from a raw combustion residue at least one of lumps and clumps, wherein the raw combustion residue selectively includes a non combustion material,
a screening means configured to remove the non combustion material from the raw combustion residue, wherein said raw combustion residue selectively includes non combustion material and wherein said screening means for screening said raw combustion material is operated to separate said non combustion material from said raw combustion material to form screened combustion material,
a drying means configured to remove moisture from the raw combustion residue,
wherein the residue preparation system is configured to receive at least one of the raw combustion residue and the screened combustion material to produce a processed combustion residue by operation of at least one of the declumping means and the drying means;
a grading means configured to form from the processed combustion residue a first output of first particles sized to be no larger than a selected size, the first output including first particles having first effective shapes, and a second output of second particles sized larger than the selected size of the first particles;
a size reduction means connected to receive the second particles from the grading means, wherein the size reduction means is operable to form the second particles into third particles, wherein the third particles are sized to be no larger than the selected size, wherein the size reduction means forms a portion of the third particles into the first effective shapes and forms another portion of the third particles to have second effective shapes which are different from the first effective shapes;
a blending means connected to receive the first particles from the first output of the grading means and the third particles from the size reduction means, wherein the blending means is configured to form blended particles from the first particles and the third particles; and
a mixing means connected to the blending means, wherein the mixing means is configured to mix the blended particles with a resin and an additive.
